(19) United States
(12) Patent Application Publication
(10) Pub. No.: US 2017/0098218 A1
(43) Pub. Date: Apr. 6, 2017

(54) METHOD AND SYSTEM FOR DISTRIBUTION OF SOCIAL BENEFITS

(71) Applicant: MasterCard International Incorporated, Purchase, NY (US)

(72) Inventor: Wesley Frederico Espinal RIOS, Sao Paulo (BR)

(73) Assignee: MASTERCARD INTERNATIONAL INCORPORATED, Purchase, NY (US)

(21) Appl. No.: 14/874,958

(22) Filed: Oct. 5, 2015

(51) Int. Cl. G06Q 20/40

(52) U.S. Cl. CPC G06Q 20/4014

(57) ABSTRACT

A method for selective application of rules to transaction processing for mapped transaction accounts includes: storing account profiles having an account identifier, mapped account identifiers, and a primary account number; storing rule profiles having mapped account identifiers and transaction rules; receiving a program selection including the account identifier and a selected mapped account identifier; receiving a transaction message via a payment network including the primary account number and transaction data; identifying a rule profile having the selected mapped account identifier; determining compliance with the transaction rules in the rule profile based on the transaction data; replacing the primary account number in the transaction message with an account number associated with the selected mapped account identifier if the transaction is determined to be compliant with the transaction rules; and transmitting the transaction message to a financial institution.

### FIELD

The present disclosure relates to the distribution of social benefits through a payment infrastructure, specifically the selective application of rules to payment transactions for mapped transaction accounts that correspond to social benefits available to a consumer.

### BACKGROUND

Many countries offer a number of social benefit programs to their citizens and residents. Social benefit programs may be offered for a variety of different reasons and uses, such as for food purchases, clothing purchase, housing costs, home furnishings, transportation, and more. Unfortunately, in many instances these programs are managed by different organizations and governmental agencies. As a result, not only can the rules for usage of these social benefits in transactions can vary, but the methods of disbursement and use of social benefits may also vary greatly.

For instance, a country may provide four different social benefits programs to an individual, each of which may be managed by a different entity. Each program may use a different method for disbursement and payment, such as each using a separate prepaid debit card that may have a different account number and may even have different branding, and thus be usable at different merchants. As such, an individual that may receive social benefits for multiple programs may be required to carry and use multiple payment cards. This may be difficult for some individuals who must keep track of which card corresponds to which benefit, must keep track of which card must be presented to which merchants, and may be worried about theft due to the number of payment cards being carried around.

Thus, there is a need for a technical solution where multiple social benefits may be provided to an individual and used without the need for multiple payment methods. Some methods have been developed to enable a payment card to be associated with multiple payment accounts, such as described in U.S. Pat. No. 7,359,880, entitled “System and Method for Consumer Control over Card-Based Transactions,” by Luther C. Abel et al., filed on Aug. 5, 2005, which is herein incorporated by reference in its entirety, where the payment account used is selected based on attributes of the transaction being processed as specified by the individual. However, such methods may be ill-suited for use with social benefit programs, where the providers of the social benefits set restrictions on usage of the associated account that are not modifiable by the individual. In addition, in such methods the individual may be unable to manually select the account to be applied to the transaction prior to the transaction being processed, which may be problematic in instances where multiple social benefits may be applicable to a particular merchant or transaction.

### SUMMARY

The present disclosure provides a description of systems and methods for selective application of rules to transaction processing for mapped transaction accounts.

A method for selective application of rules to transaction processing for mapped transaction accounts includes: storing, in a mapping database of a processing server, a mapping profile, wherein the mapping profile includes data related to a transaction account including at least an account identifier, a primary account number, a plurality of mapped identifiers, and, for each of the mapped identifiers, an associated mapped account number; storing, in an account database of the processing server, a plurality of account profiles, wherein each account profile includes data related to a transaction account including at least a mapped identifier of the plurality of mapped identifiers, the associated mapped account number, and one or more transaction rules, each transaction rule applicable to transaction data for a payment transaction; receiving, by a receiving device of the processing server, an electronic signal via a communication network comprising an account selection, wherein the account selection includes at least the account identifier and a selected mapped identifier of the plurality of mapped identifiers; receiving, by the receiving device of the processing server, a transaction message via a payment network, wherein the transaction message is formatted based on one or more standards and includes a plurality of data elements including at least a first data element configured to store the primary account number and one or more additional data elements configured to store transaction data; executing, by a processing device of the processing server, a query on the account database to identify a specific account profile where the included mapped identifier corresponds to the specific mapped identifier included in the received account selection; determining, by the processing device of the processing server, compliance of the payment transaction with the one or more transaction rules included in the identified specific account profile based on an application of the one or more transaction rules to the transaction data stored in the one or more additional data elements included in the received transaction message; replacing, by the processing device of the processing server, the primary account number stored in the first data element included in the received transaction message with the associated mapped account identifier included in the identified specific account profile if the payment transaction is determined to be compliant with the one or more transaction rules; and electronically transmitting, by a transmitting device of the processing server, the received transaction message to a financial institution via the payment network.

A system for selective application of rules to transaction processing for mapped transaction accounts includes a mapping database, an account database, a receiving device, a processing device, and a transmitting device of a processing server. The mapping database of the processing server is configured to store a mapping profile, wherein the mapping profile includes data related to a transaction account including at least an account identifier, a primary account number, a plurality of mapped identifiers, and, for each of the mapped identifiers, an associated mapped account number. The account database of the processing server is configured to store a plurality of account profiles, wherein each account profile includes data related to a transaction account including at least a mapped identifier of the plurality of mapped identifiers, the associated mapped account number, and one or more transaction rules, each transaction rule applicable to transaction data for a payment transaction. The receiving device of the processing server is configured to receive: an electronic signal via a communication network comprising an account selection, wherein the account selection includes at least the account identifier and a selected mapped identifier of the plurality of mapped identifiers; and a transaction message via a payment network, wherein the transaction message is formatted based on one or more standards and includes a plurality of data elements including at least a first data element configured to store the primary account number and one or more additional data elements configured to store transaction data. The processing device of the processing server is configured to: execute a query on the account database to identify a specific account profile where the included mapped identifier corresponds to the specific mapped identifier included in the received account selection; determine compliance of the payment transaction with the one or more transaction rules included in the identified specific account profile based on an application of the one or more transaction rules to the transaction data stored in the one or more additional data elements included in the received transaction message; and replace the primary account number stored in the first data element included in the received transaction message with the associated mapped account identifier included in the identified specific account profile if the payment transaction is determined to be compliant with the one or more transaction rules. The transmitting device of the processing server is configured to electronically transmit the received transaction message to a financial institution via the payment network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the selective application of rules to transaction processing for distribution and use of social benefits in accordance with exemplary embodiments.

FIG. 2 is a block diagram illustrating the processing server of FIG. 1 for the selective application of rules in transaction processing in accordance with exemplary embodiments.

FIG. 3 is a flow diagram illustrating a process for selective application of rules to a payment transaction based on consumer social benefit selection using the system of FIG. 1 in accordance with exemplary embodiments.

FIG. 4 is a flow diagram illustrating a process for selective application of rules for social benefit programs for transaction processing using the processing server of FIG. 2 in accordance with exemplary embodiments.

FIG. 5 is a flow diagram illustrating an exemplary method for selective application of rules to transaction processing for mapped transaction accounts in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc. In some instances, as used herein, the term “issuer” may refer to an apparatus or device of an issuer entity.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Selective Application of Rules to Transactions for Social Benefits

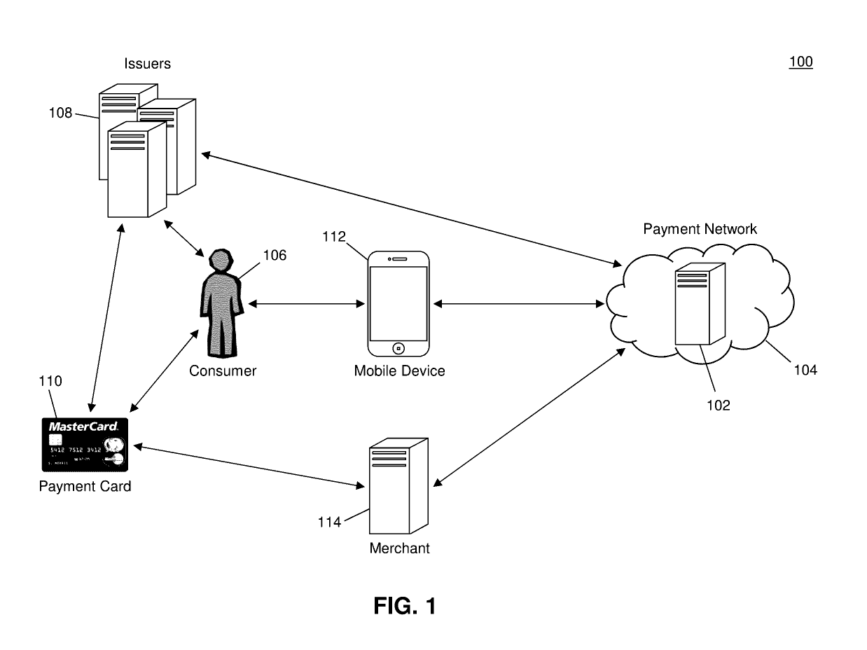

FIG. 1 illustrates a system 100 for the selective applications to rules in transaction processing for the disbursement and use of social benefits.

The system 100 may include a processing server 102. The processing server 102, discussed in more detail below, may be configured to selectively apply rules to payment transactions using mapped transaction accounts that correspond to social benefit programs. The processing server 102 may be a part of a payment network 104 configured to process payment transactions where the processing server 102 may perform additional processing of payment transactions in addition to the selective application of rules and mapping of transaction accounts.

In the system 100, a consumer 106 may be a beneficiary in a plurality of social benefit programs. Each social benefit program may be associated with an issuer 108. Issuers 108 may be financial institutions configured to operate and manage transaction accounts for use in funding payment transactions. The consumer 106 may be provided access to a transaction account with an issuer 108 for each social benefit program to which the consumer 106 is a beneficiary. In some embodiments, a social benefit program may be associated with a single transaction account at an issuer 108 that is associated with multiple consumers 106. That is to say, each consumer 106 beneficiary of the social benefit program may be able to transact using the single transaction account, where the managing issuer 108 or social benefit provider may track usage of the social benefit. In other embodiments, each consumer 106 beneficiary of a social benefit may be issued a separate transaction account with an issuer 108.

The consumer 106 may be issued a payment card 110. The payment card 110 may be associated with one or more issuers 108, which may be included in or may be separate from issuers 108 associated with the social benefit programs. The payment card 110 may be associated with a primary account number, which may be an account number suitable for use in payment transactions for the funding thereof. The primary account number may be encoded in the payment card 110, such as in instances where the payment card 110 may be a physical card, or may be otherwise associated with the payment card 110 such that the primary account number may be conveyed as part of payment details presented when the payment card 110 is used to fund a payment transaction. In the case of a physical card, in some instances, the primary account number may be stored on a medium such as a magnetic stripe or an integrated circuit chip of the physical card. In some embodiments, the payment card 110 may be a virtual payment card that is stored in an electronic wallet application program of a mobile device 112, where the primary account number is stored in payment credentials stored in the mobile device 112 or otherwise accessible via the mobile device 112 using methods that will be apparent to persons having skill in the relevant art. The primary account number may be configured to provide routing information so as to cause a transaction proposed to be funded with the payment card 110 to be routed to the appropriate device for transaction processing.

The payment card 110 may be associated with each of the social benefit programs to which the consumer 106 is a beneficiary. The processing server 102 may store an account profile that corresponds to the payment card 110 that includes identifiers mapping the payment card 110 to each of the transaction accounts at the issuers 108 associated with the social benefits to which the consumer 106 is a beneficiary. As discussed in more detail below, the processing server 102 may be configured to identify a mapped transaction account for use in funding a payment transaction when the payment card 110 is used, based on a selection by the consumer 106.

The mobile device 112 may be used by the consumer 106 to select a transaction account for a social benefit to be used in a future payment transaction. The mobile device 112 may be any type of computing device suitable for performing the functions discussed herein, such as a cellular phone, smart phone, tablet computer, laptop computer, notebook computer, wearable computing device, implantable computing device, etc. In some instances, the consumer 106 may use any suitable type of computing device including devices that may not traditionally be considered mobile devices, such as desktop computers, smart televisions, etc.

The mobile device 112 may be configured to execute an application program, which may enable the consumer 106 via one or more input methods to select a social benefit program from the plurality of social benefit programs to which they are a beneficiary for use in future payment transactions. The application program may be stored locally on the mobile device 112 and executed thereby, or may be stored remotely and accessed via the mobile device 112 using a suitable communication network, such as a cellular communication network, using known techniques, such as cloud computing techniques. The application program may display, for instance, a list of each social benefit program to the consumer 106. The mobile device 112 may receive input from the consumer 106, such as via a keyboard, click wheel, scroll wheel, touch screen, microphone, camera, etc., indicating one of the social benefit programs.

The mobile device 112 may then generate a data signal that is superimposed with information identifying the selected social benefit program and the consumer account profile. The information may include, for instance, an account identifier for the account profile and an identifier for the social benefit program. The information may be superimposed on the data signal using methods and systems that will be apparent to persons having skill in the relevant art. The mobile device 112 may electronically transmit the data signal to the processing server 102 using a suitable communication network and method. For instance, the data signal may be transmitted via a cellular communication network, local area network, wireless area network, the Internet, radio frequency, near field communication, etc.

The processing server 102 may receive the data signal from the mobile device 112 and may parse the data signal to obtain the information superimposed thereon. The parsing of the data signal may include deconstruction of the data signal into data elements comprising the information identifying the selected social benefit program and the account profile. The processing server 102 may execute a query on a database configured to store account profiles to identify the account profile associated with the consumer 106 using the account identifier. The processing server 102 may then store an indication in the account profile of the social benefit program selected by the consumer 106. In some embodiments, the selection may be used for all future payment transactions using the payment card 110 until a new selection is made. In other embodiments, the selection may be used for only the next payment transaction (e.g., or for a predetermined number of transactions or predetermined length of time), at which time a new selection must be made before further use of the payment card 110. In some instances, the payment card 110 may be disabled or turned “off” for future transactions of the selected account profile after single-use, multiple-uses, or a predetermined amount of time (e.g., which may be specified by an issuer or social benefit provider associated with the account via communication with the processing server 102).

Once the consumer 106 has made his or her selection, the consumer 106 may use the payment card 110 at a merchant 114 to fund a payment transaction. The consumer 106 may present the payment card 110 to a point of sale device at the merchant 114. The point of sale device may read payment details from the payment card 110, or otherwise receive payment details associated with the payment card 110, for use in processing the payment transaction. In instances where the transaction may be an in-person transaction, such as conducted at a physical location of the merchant 114, the point of sale device may obtain the payment details via reading the payment details from a physical payment card 110 (e.g., via a magnetic stripe reader, a chip reader, etc.), receiving the payment details from a mobile device (e.g., the mobile device 112) using near field communication, or other suitable method. In instances where the transaction may be a remote transaction, such as an e-commerce transaction conducted via the Internet, the point of sale device may receive the payment details via an electronically transmitted data signal superimposed with payment details as input into a computing device by the consumer 106. The payment details may include, for instance, the primary account number associated with the payment card 110, payment cryptograms, consumer data (e.g., name, billing address information, etc.), and any other data that may be suitable for use in the processing of payment transactions. The received primary account number may comprise data that specifies a routing destination specifying a device to which the payment details should be routed, such as to the issuer 108 associated with the transaction account corresponding to the primary account number.

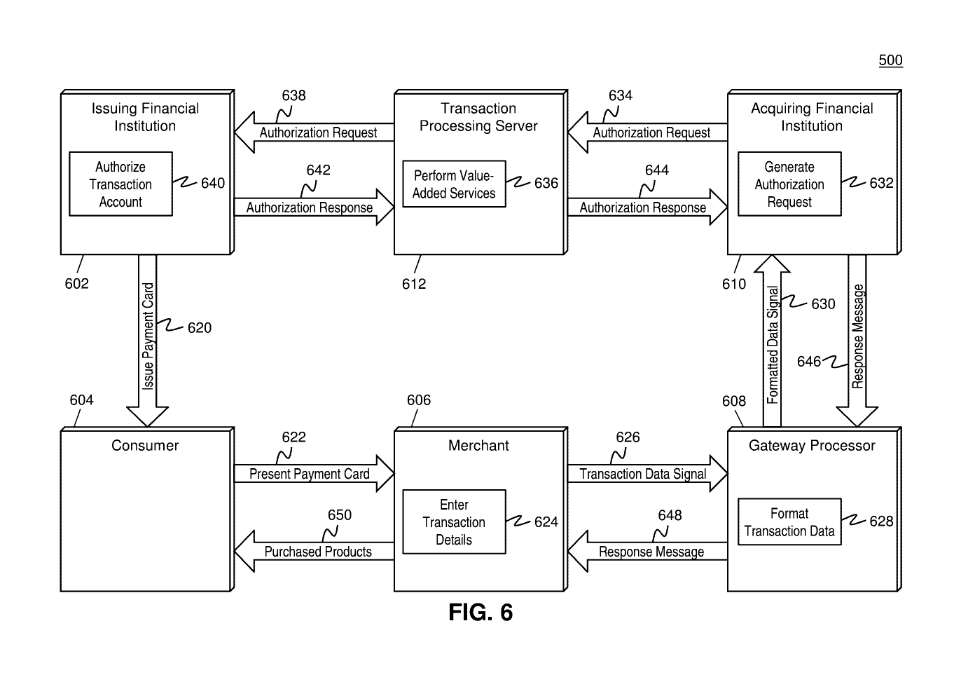

The point of sale system at the merchant 114 may receive the payment details and may include the payment details in transaction data for the payment transaction. The transaction data may also include a transaction amount, transaction time and/or date, and any other suitable data, such as product data, merchant data, point of sale data, offer data, reward data, loyalty data, etc. The merchant 114 and/or point of sale system may submit the transaction data for processing of the payment transaction. The transaction data may be submitted to an acquiring financial institution, gateway processor, or other entity prior to transmission to the processing server 102. The processing server 102 may receive a transaction message, which may be a specially formatted data message that is formatted pursuant to one or more standards governing the formatting and transmission of transaction messages, for the payment transaction via the payment rails. The payment rails may be a specialized communication network comprising specially configured infrastructure and hardware specifically programmed for the transmission and exchange of transaction messages and payment information. Additional detail regarding the payment rails and the processing of payment transactions is discussed in more detail below with respect to the process 600 illustrated in FIG. 6.

The transaction message received by the processing server 102 may include a plurality of data elements, each configured to store data as set forth in the associated standards. The data elements may comprise transaction data as submitted by the merchant 114, such as data elements configured to store payment details including a data element configured to store the primary account number of the payment card 110. In some instances, the transaction message may include or otherwise be associated with a message type indicator, which may be indicative of the transaction message being an authorization request. The processing server 102 may parse the received transaction message to identify the data elements included therein. The processing server 102 may then identify the account profile involved in the payment transaction using the primary account number parsed from the transaction message (e.g., via a mapping process whereby the primary account number is mapped to a corresponding representative value stored in an electronic database comprising data entries associated with one or more account profiles).

Once the account profile is identified, the processing server 102 may identify the social benefit program to be used for the payment transaction, based on the indication stored in the account profile as a result of the earlier selection received from the mobile device 112. The processing server 102 may then apply rules to the payment transaction based on the selected social benefit program. The rules may be supplied by the corresponding issuers 108 and/or agencies involved with the respective social benefit programs. The processing server 102 may apply the rules for the selected social benefit program to the payment transaction to determine if the transaction is in compliance with the social benefit program. Each rule may include one or more conditions and may be associated with one or more data elements. The processing server 102 may identify the rules applicable to a payment transaction and may determine compliance with the rules based on the data value of the corresponding data element(s) parsed from the transaction message and the respective conditions.

For example, a social benefit program that provides a food allowance to a consumer 106 may set a rule that the program may only be used at restaurants, grocery stores, or convenience stores. The rule may be stored in the processing server 102 with a condition that a merchant category code stored in a corresponding data element included in a transaction message is equal to a value that is associated with restaurants, grocery stores, or convenience stores. If the consumer 106 selects that social benefit program for use in their next transaction using the mobile device 112, the processing server 102 would apply that rule to the transaction message received for the payment transaction. The processing server 102 would parse the transaction message and identify the data element configured to store the merchant category code. The processing server 102 would determine if the merchant category code is equal to a value associated with a restaurant, grocery store, or convenience store.

If the processing server 102 determines that the payment transaction complies with the rules of the social benefit program, then the processing server 102 may modify the transaction message by replacing the primary account number included therein with an account number associated with the social benefit program as included in the account profile. The processing server 102 may then electronically transmit the transaction message with the mapped account number to the corresponding issuer 108. The issuer 108 may then approve or deny the transaction using traditional methods, and provide a response transaction message to the processing server 102 and/or payment network 104 for additional processing. The additional processing may include traditional payment transaction processing functions as discussed below, and may include the remapping of the original primary account number in the transaction message prior to forwarding to the merchant 114 (e.g., via one or more additional entities, such as an acquiring financial institution and a gateway processor, as discussed below).

If the processing server 102 determines that the payment transaction does not comply with the rules of the social benefit program, the processing server 102 may deny the payment transaction. Denial of the payment transaction may include, for example, including a response code in a corresponding data element of the transaction message that indicates denial of the payment transaction. In some instances, the response code may further indicate that the transaction is denied for non-compliance with the program rules. The transaction message may also be modified to be indicative of an authorization response, such as by modifying a message type indicator associated with the transaction message. The processing server 102 may then return the transaction message via the payment rails, such as to an acquiring financial institution or other entity, for reporting to the merchant 114. In some instances, the processing server 102 may also electronically transmit a notification to the associated issuer 108 or entity involved with the social benefit program regarding the denied payment transaction.

The processing server 102 may thus be configured to selectively apply rules to payment transactions for a plurality of different social benefit programs for the processing of transactions using different transaction accounts mapped to each social benefit program. By using account mapping, a single payment card 110 may be used by the consumer 106 to use multiple different social benefit programs without the need to carry multiple payment cards. Furthermore, enabling the consumer 106 to provide a selection as to the social benefit program to be applied, the processing server 102 may quickly and efficiently apply the correct set of rules to the transaction, including in instances where a transaction may be suitable for multiple social benefit programs. In addition, the selective application of the rules for the select social benefit program during the processing of the transaction can ensure that the transaction is processed only if in compliance with the conditions of the respective program. As a result, the processing server 102 may provide for an improved transaction processing system that can intelligently process payment transactions based on selectively applied rules for multiple mapped transaction accounts, with the payment transaction originating from a single payment card 110, resulting in a more efficient and technologically superior process.

### Processing Server

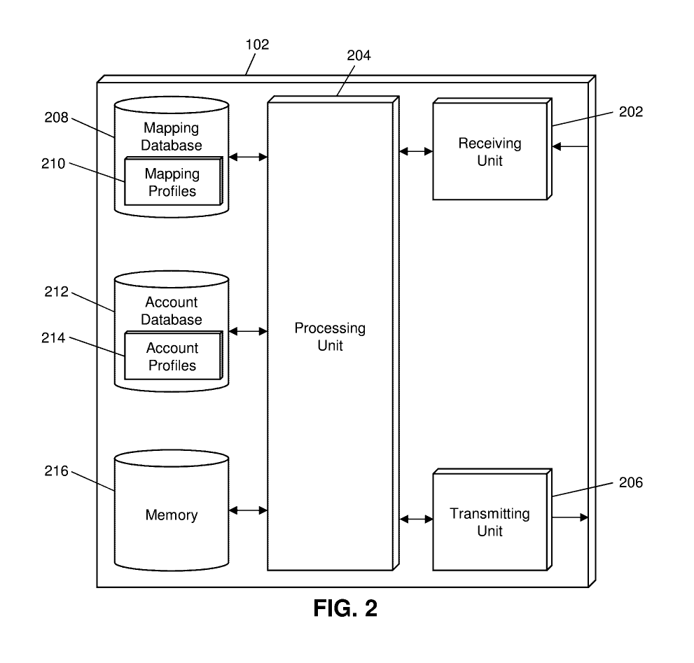

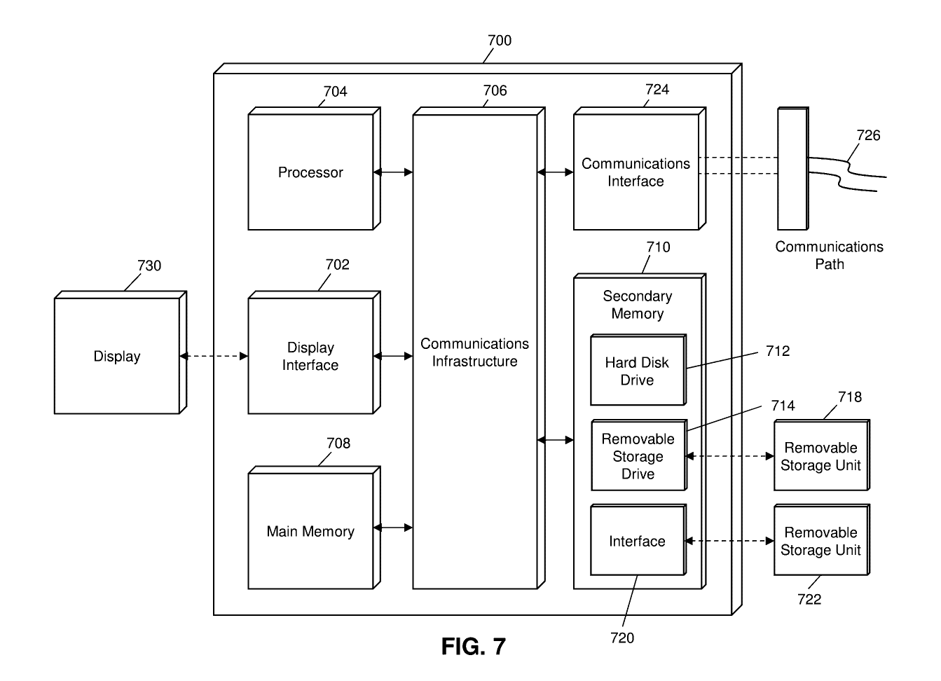

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. In some embodiments, the receiving unit 202 may be configured to receive data over the payment rails, such as using specially configured infrastructure associated with payment networks 104 for the transmission of transaction messages that include sensitive financial data and information. In some instances, the receiving unit 202 may also be configured to receive data from mobile devices 112, computing devices, issuers 108 and other entities via alternative networks, such as the Internet. In some embodiments, the receiving unit 202 may be comprised of multiple units, such as different receiving units for receiving data over different networks, such as a first receiving unit for receiving data over payment rails and a second receiving unit for receiving data over the Internet. The receiving unit 202 may receive electronically data signals that are transmitted, where data may be superimposed on the data signal and decoded, parsed, read, or otherwise obtained via receipt of the data signal by the receiving unit 202. In some instances, the receiving unit 202 may include a parsing module for parsing the received data signal to obtain the data superimposed thereon. For example, the receiving unit 202 may include a parser program configured to receive and transform the received data signal into usable input for the functions performed by the processing unit to carry out the methods and systems described herein.

The receiving unit 202 may be configured to receive data signals from issuers 108 that are superimposed with data associated with social benefit programs. The data may include mapped account numbers associated with a payment card 110 and/or a consumer 106 to be mapped to the payment card 110. The data may include data indicative of the associated payment card 110 and/or consumer 106, such as the primary account number, an account identifier, etc.

The receiving unit 202 may also be configured to receive data signals superimposed with transaction rules from the issuer 108 or other entity (e.g., a governmental agency or organization, the benefit provider, etc.) that are associated with a social benefit program for selective application to payment transactions for which the respective social benefit program is selected. In some embodiments, the data signals superimposed with transaction rules may further comprise data identifying one or more pre-existing account profiles and/or providing data related to one or more account profiles to be created. The data signals may be received and parsed and supplied as the input for one or more processes executed by the processing unit 204. The input data may cause the processing unit 204 to update pre-existing data fields associated with pre-existing account profiles (e.g., of an account profile database). The input data may cause the processing unit 204 to generate new data fields and associate the new data fields with one or more pre-existing account profiles. The input data may cause the processing unit 204 to generate a new data entry as a new account profile. In some embodiments, the data signals may be received from a computing device associated with, e.g., the benefit provider or issuer 108. The benefit provider or issuer 108 may be required to authenticate the source of the data signals prior to accessing the receiving unit 202 and/or prior to updating the data stored at the processing server 102.

The receiving unit 202 may be further configured to receive data signals electronically transmitted by the mobile device 112 or other computing device superimposed with an account selection. The account selection may include an account identifier associated with the consumer 106 and/or payment card 110 that includes an indication of the selected social benefit program to be applied to at least the next payment transaction where the payment card 110 is used.

The processing server 102 may also include a processing unit 204. The processing unit 204 may be configured to perform the functions of the processing server 102 discussed herein as will be apparent to persons having skill in the relevant art. In some embodiments, the processing unit 204 may include and/or be comprised of a plurality of engines and/or modules specially configured to perform one or more functions of the processing unit 204. As used herein, the term “module” may be software or hardware particularly programmed to receive an input, perform one or more processes using the input, and provide an output. The input, output, and processes performed by various modules will be apparent to one skilled in the art based upon the present disclosure.

For example, the processing unit 204 may include a querying module configured to query databases included in the processing server 102 to identify information stored therein. For example, the querying module may receive an input of an account number or another account identifier (e.g., output from a parsing module, etc.) and execute a query for an identical account number stored as a value associated with an account stored in a database. In some instances, the processing unit 204 may include a parsing module or engine configured to parse data from data signals electronically received by the receiving unit 202, an encryption module or engine configured to decrypt received data or data signals or to encrypt data or data signals received or transmitted by the processing server 102, and any other modules suitable for performing the functions discussed herein.

The processing server 102 may include a mapping database 208. The mapping database 208 may be configured to store a plurality of mapping profiles 210 using any suitable data storage format and schema. Each mapping profile 210 may include a standardized data set including data related to a transaction account and include at least an account identifier, a primary account number, a plurality of mapped identifiers, and, for each mapped identifier, an associated mapped account number. The account identifier may be a unique value suitable for use in identification of the mapping profile 210 and/or payment card 110 or consumer 106 associated with the related transaction account. The account identifier may be, for instance, the primary account number, a registration number, a serial number, an identification number, a device identifier (e.g., associated with the mobile device 112) such as a media access control address, a username, an e-mail address, a phone number, a street address, etc.

The primary account number may be the account number associated with the related transaction account, which may be included in payment details of the payment card 110 that are provided to merchants 114 when the payment card 110 is presented to fund a payment transaction. The plurality of mapped identifiers may include an identification value that corresponds to a transaction account associated with a social benefit program. The mapped identifier may be, for instance, the associated mapped account number, an identification number, a registration number, a social benefit name, etc. The associated mapped account number may be an account number associated with the transaction account associated with the corresponding social benefit program. In some instances, the mapped identifier may be a unique value.

The processing server 102 may also include an account database 212. The account database 212 may be configured to store a plurality of account profiles 214 using a suitable data storage format and schema. Each account profile 214 may include a standardized data set of data related to a transaction account for a social benefit program including at least one mapped identifier, the associated mapped account number, and one or more transaction rules. In some instances, an account profile 214 may include a plurality of mapped identifiers, such as in instances where multiple consumers 106 as beneficiaries of a social benefit program may transact using the same transaction account for the social benefit program. The one or more transaction rules may be applicable to one or more data elements of a transaction message and include one or more conditions regarding data values of the applicable one or more data elements.

The processing unit 204 of the processing server 102 may be configured to selectively apply transaction rules to payment transactions. When a transaction message is received by the receiving unit 202 and parsed by the receiving unit 202 or a parsing module of the processing unit 204, the processing unit 204 may identify the primary account number included in the corresponding data element. The processing unit 204 may include a querying module that may execute a query on the mapping database 208 to identify a mapping profile 210 that includes the primary account number. For instance, the querying module may receive as an input the primary account number output by the parsing module. The identified mapping profile 210 may be output by the querying module and may be input into an account identification module, which may be configured to use the account selection made by the consumer 106 (e.g., as parsed from the data signal received from the mobile device 112 by the receiving unit 202) to identify the mapped identifier and/or associated mapped account number in the mapping profile 210 corresponding to the selection made by the consumer 106. The account identification module may output the mapped identifier, which may be included in a query input into the querying module and executed on the account database 212 to identify the account profile 214 associated with the selected social benefit program that includes the mapped identifier.

In some alternative embodiments, a secondary account identification module may be configured to receive an input of the primary account number parsed from the received transaction message and identify, in a primary account database, a primary account profile associated with the received primary account number (e.g., via a querying process). In such embodiments, the primary account database may include one or more secondary accounts corresponding to accounts managed by benefits program providers. The secondary account identification module may identify a primary account data entry and cause a query to be executed on the primary account data entry. The primary account data entry may include data identifying one or more secondary account identifiers associated with the primary account and a value associated with the one or more secondary accounts which indicates a status of the one or more secondary accounts (e.g., a flag indicating that the account is on/off, currently available for use, etc.). The data related to the secondary accounts may be associated with a flag and updated based upon data received from the consumer, issuer, and or social benefit provider, as described herein. The authorized account query may identify a secondary account identifier associated with a flagged, or otherwise identified, data entry. The secondary account identifier may be output by the secondary account identification module to be fed into the account identification module, as described in more detail above. It will be apparent to persons having skill in the relevant art that additional, alternative data storage configurations may be utilized in conjunction with the methods discussed herein.

Once the account profile 214 is identified, a determination module may apply the one or more transaction rules included in the account profile 214 to the data elements parsed from the received transaction message. The determination rule may apply each transaction rule via evaluation of the condition included in the transaction rule and the data value stored in the indicated data element(s) of the transaction message associated with the transaction rule. The determination module may output a determination if the related payment transaction is in compliance with each of the transaction rules applied to the transaction message.

The output may be fed as input to a transaction processing module, which may process the payment transaction accordingly based on the determination. For instance, if the determination is that the transaction is in compliance, the transaction processing module may swap the primary account number stored in the corresponding data element of the transaction message with the associated mapped account number, and may initiate transmission of the modified transaction message to the corresponding issuer 108 for processing. For instance, the transaction processing module may update the transaction message by replacing the value representing the account number for funding the proposed transaction with the identified mapped account number. The mapped account number may be configured to identify the appropriate destination device to which to route the transaction message. If the determination is that the transaction is not in compliance, the transaction processing module may modify a response code stored in the corresponding data element of the transaction message to indicate denial of the payment transaction and may modify a message type indicator to indicate the transaction message as being an authorization response, and may initiate transmission of the modified transaction message to the merchant 114 point of sale device from which the transaction message originated and/or another entity. In some embodiments, the processing unit 204 may include an account updating module. The account updating module may be configured to utilize the social benefit program selection received from the mobile device 112 and update the corresponding mapping profile 210. The update may consist of storing the selection in the mapping profile 210 such that the selected mapped identifier and/or associated mapped account number is identified by the account identification module for use when processing payment transactions.

The processing server 102 may further include a transmitting unit 206. The transmitting unit 206 may be configured to transmit data over one or more networks via one or more network protocols. In some embodiments, the transmitting unit 206 may be configured to transmit data over the payment rails, such as using specially configured infrastructure associated with payment networks 104 for the transmission of transaction messages that include sensitive financial data and information, such as identified payment credentials. In some instances, the transmitting unit 206 may be configured to transmit data to issuers 108, mobile devices 112, merchants 114, and other entities via alternative networks, such as the Internet. In some embodiments, the transmitting unit 206 may be comprised of multiple units, such as different transmitting units for transmitting data over different networks, such as a first transmitting unit for transmitting data over the payment rails and a second transmitting unit for transmitting data over the Internet. The transmitting unit 206 may electronically transmit data signals that have data superimposed that may be parsed by a receiving computing device. In some instances, the transmitting unit 206 may include one or more modules for superimposing, encoding, or otherwise formatting data into data signals suitable for transmission.

The transmitting unit 206 may be configured to transmit modified transaction messages to the issuers 108, merchants 114, or other entities using the payment rails. The transmitting unit 206 may also be configured to electronically transmit data signals superimposed with data to the mobile device 112 using suitable communication networks and protocols. For instance, the transmitting unit 206 may transmit mapped identifiers to the mobile device 112 for selection, notifications regarding selected social benefit programs, and other data that will be apparent to persons having skill in the relevant art.

The processing server 102 may also include a memory 216. The memory 216 may be configured to store data for use by the processing server 102 in performing the functions discussed herein. The memory 216 may be configured to store data using suitable data formatting methods and schema and may be any suitable type of memory, such as read-only memory, random access memory, etc. The memory 216 may include, for example, encryption keys and algorithms, communication protocols and standards, data formatting standards and protocols, program code for modules and application programs of the processing unit 204, and other data that may be suitable for use by the processing server 102 in the performance of the functions disclosed herein as will be apparent to persons having skill in the relevant art.

### Process for Selection of a Social Benefit Program

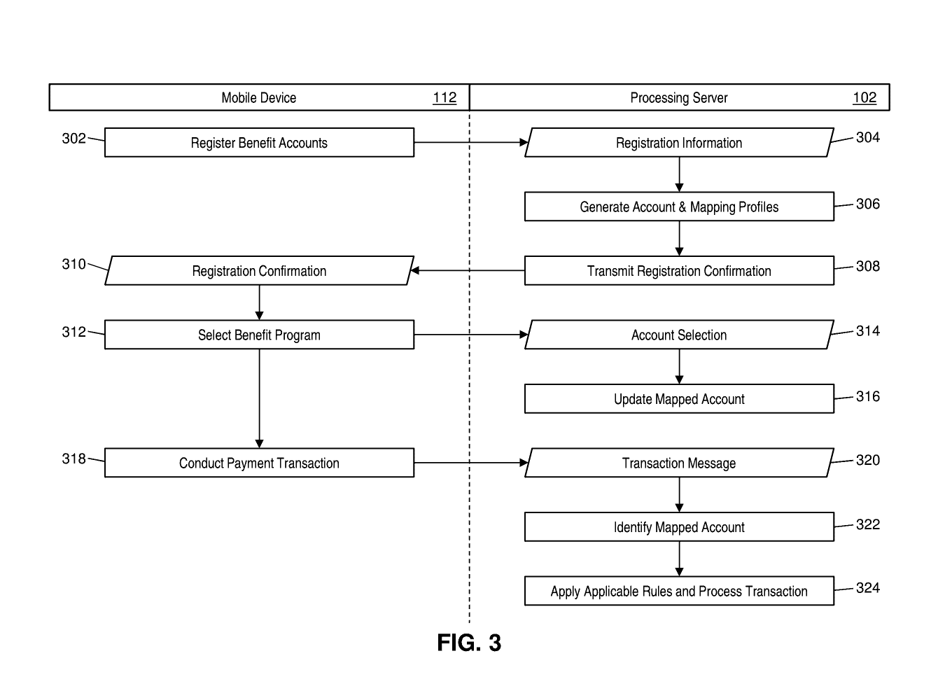

FIG. 3 illustrates a process 300 for the selection of a social benefit program to be used in a payment transaction as part of the system 100 of FIG. 1.

In step 302, the consumer 106 may utilize the mobile device 112 to register their social program benefit accounts for use with the payment card 110. Registration may include the electronic transmission of a data signal superimposed with at least mapped identifiers associated with each social benefit program and the account identifier associated with the payment card 110. In step 304, the receiving unit 202 of the processing server 102 may receive the data signal superimposed with the registration information. The parsing module of the receiving unit 202 or the processing unit 204 may parse the data signal to deconstruct the data signal and obtain the mapped identifiers and account identifier. In some embodiments, the registration may be performed by an authorized benefit provider via an authorized benefit provider account configured to transmit registration data to the receiving unit 202, as described herein, in a manner similar to that conducted by the consumer via the mobile device 112 (or via another device).

In step 306, an account generation module of the processing unit 204 may generate a mapping profile 210 for storage in the mapping database 208. The mapping profile 210 may be generated based upon the data received via the receiving unit 202 for registering the one or more benefits accounts and instructions stored on a memory of the processing unit 204 for generating a new account profile (e.g., instructions for generating a new data entry of a standard format populated with data received via the receiving unit 202 unique to associated registration. The mapping profile 210 may include at least the account identifier and mapped identifiers included in the received registration information. In some instances, the registration information may also include the primary account number associated with the payment card 110, which may be included in the generated mapping profile 210. In other instances, the processing server 102 may generate the primary account number or otherwise identify the primary account number associated with the account identifier for inclusion in the mapping profile 210. For instance, the processing server 102 may generate the primary account number via a random number generator or based upon a pre-identified format which ensures that a new and unique primary account number is generated. In some instances, the processing server 102 may generate the primary account number by selecting (at random or according to a pre-programmed algorithm) an account number from a list of available primary account numbers, stored in a memory of the processing server 102 or an external memory accessible by the processing server 102. In embodiments where a mapping profile 210 already exists that includes the account identifier, the mapped identifier included in the registration information may be added to the mapped identifiers in the mapping profile 210 (e.g., by generating new data fields populated with the registration information).

Also in step 306, the account generation module may also generate one or more account profiles 214 for storage in the account database 212, if applicable. An account profile 214 may be generated if an account profile 214 does not already exist that includes a mapped identifier included in the registration information, such as in instances where a social benefit program account may be associated with a single individual. For instance, the processing server may execute a query on the account database 212 to determine if an account profile corresponding to data received in the registration process exists within the account profile database. In such instances, the transmitting unit 206 of the processing server 102 may electronically transmit a data signal superimposed with an account number request to the issuer 108 or entity associated with the social benefit program account that includes the mapped identifier and other suitable information, and the receiving unit 202 may receive a data signal in response that is superimposed with the associated mapped account number. The account profile 214 may then be generated and include the mapped identifier and the associated mapped account number.

In step 308, the transmitting unit 206 of the processing server 102 may electronically transmit a data signal superimposed with a notification to the mobile device 112 using a suitable communication network to notify the consumer 106 that the social benefit program accounts were successfully registered. In step 310, the mobile device 112 may receive the notification, which may be displayed to the consumer 106 via a display device of the mobile device 112. In step 312, the mobile device 112 may receive a social benefit program selection as input by the consumer 106 using a suitable input method. The mobile device 112 may electronically transmit a data signal superimposed with the account identifier and the program selection to the processing server 102. In some instances, the account selection may consist of the mapped identifier associated with the select social benefit program account.

In step 314, the receiving unit 202 of the processing server 102 may receive the data signal and the parsing module of the receiving unit 202 or processing unit 204 may parse the data signal to obtain the selection superimposed thereon. In step 316, the mapping profile 210 may be updated to include the indication of the selected social benefit program. The updating may include execution of a query by the querying module of the processing unit 204 on the mapping database to identify the mapping profile 210 that includes the account identifier included in the selection, and then updating of the mapping profile 210 by the account updating module of the processing unit 204 to include the indication of the selected social benefit program corresponding to the mapped identifier included in the selection.

In step 318, the consumer 106 associated with the mobile device 112 may conduct a payment transaction where the payment card 110 is presented for payment. In some instances, the payment card 110 may be presented at a point of sale device of a merchant 114 via the mobile device 112, such as using near field communication or other suitable method for conveying payment card details. As discussed below with respect to the process 600 of FIG. 6, conducting of the payment transaction may include the submission of transaction details at the merchant 114, which may result in a transaction message that includes data elements storing data based on the transaction details being transmitted to the payment network 104 via the payment rails.

In step 320, the receiving unit 202 of the processing server 102 may receive the transaction message via the payment rails using the payment network 104. The transaction message may include a plurality of data elements including at least a first data element configured to store a primary account number (e.g., of the payment card 110) and one or more additional data elements configured to store transaction data. In step 322, the mapped account corresponding to the social benefit program to be applied to the transaction may be identified. The identification may include execution of a query by the querying module of the processing unit 204 on the mapping database 208 to identify the mapping profile 210 that includes the primary account number stored in the corresponding data element of the transaction message, and the execution of a query on the account database 212 by the querying module to identify the account profile 214 that includes the mapped identifier indicated in the selection in the identified mapping profile 210.

In step 324, the one or more transaction rules included in the identified account profile 214 may be applied to the transaction message by the determination module of the processing unit 204 to determine if the transaction is in compliance with the rules of the selected social benefit program. The payment transaction may then be processed accordingly by the transaction processing module of the processing unit 204, with the transaction message being forwarded to the issuer 108 if the transaction is in compliance, and the transaction message being forwarded to a financial institution associated with the merchant 114 if the transaction is not in compliance. Transaction rules included in the identified account profile 214 may be configured in accordance with data messages received from an issuer and/or social benefits provider associated with the account. Transaction rules may include, for example, rules specifying authorized merchants, merchant industries, merchant category codes, products, transaction amounts, aggregate transaction amounts, transaction frequency, number of transactions, geographic location, time and/or date, etc.

### Process for Selectively Applying Transaction Rules for Mapped Transaction Accounts

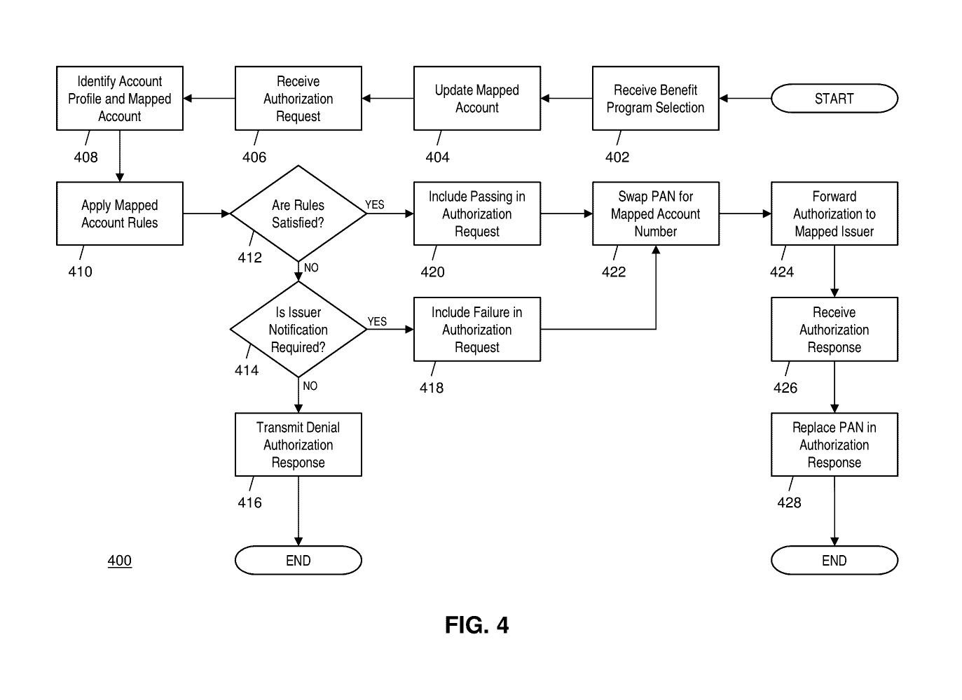

FIG. 4 illustrates a process 400 for the selective application of transaction rules to a payment transaction based on a selected mapped transaction account corresponding to a social benefit program.

In step 402, the receiving unit 202 of the processing server 102 may receive a data signal superimposed with data associated with a program benefit selection from the mobile device 112, transmitted via one or more suitable communication networks and protocols. The data may include at least an account identifier and a mapped identifier. In step 404, the mapping profile 210 associated with the account may be updated. The updating of the mapping profile 210 may comprise executing, by a querying module of the processing unit 204 of the processing server, a query on the mapping database 208 to identify the mapping profile 210 that includes the account identifier included in the received data signal, and updating the mapping profile 210 via the account updating module of the processing unit 204 to indicate that the mapped identifier is selected for use in subsequent payment transactions.

In step 406, the receiving unit 202 may receive a transaction message for a payment transaction via the payment network 104. The transaction message may be formatted based on one or more standards, such as the International Organization of Standardization's ISO 8583 standard, and include a plurality of data elements including at least a first data element configured to store a primary account number and one or more additional data elements configured to store transaction data. In some instances, the transaction message may include a message type indicator that indicates the transaction message to be an authorization request.

In step 408, an account profile 214 and mapped account may be identified for the payment transaction. The querying module of the processing unit 204 may execute a query on the mapping database 208 to identify a mapping profile 210 that includes the primary account number stored in the corresponding data element included in the received transaction message. The account identification module of the processing unit 204 may identify the mapped identifier that was selected to be applied to subsequent transactions for the mapping profile 210. The querying module may then execute a query on the account database 212 to identify an account profile 214 where the included mapped identifier corresponds to the mapped identifier identified in the mapping profile 210.

In step 410, the determination module of the processing unit 204 may apply the one or more transaction rules included in the identified account profile 214 to the transaction message. The application may include the comparison of data values stored in one or more of the additional data elements to data values in the respective one or more transaction rules to determine compliance with the transaction rules in the account profile 214. In step 412, the determination module may determine if each transaction rule was satisfied, based on the determination from each rule application. If the transaction rules are not satisfied for the transaction, then, in step 414, the determination module or another suitable module of the processing unit 204 may determine if the issuer 108 or another entity associated with the selected social benefit program is to be notified. The determination may be made on, for instance, preferences of the issuer 108 or other associated entity, such as may be stored in the memory 216 of the processing server.

If no notification to the issuer 108 or other entity is required, then, in step 416, the transmitting unit 206 may electronically transmit a denial authorization response to an appropriate entity, such as an acquiring financial institution associated with a merchant 114 involved in the payment transaction, via the payment network 104. The denial authorization response may be a modified transaction message, where the authorization request may be modified to include a response code in a corresponding data element that indicates denial of the payment transaction and a modified message type indicator to be indicative of an authorization response. If a notification to the issuer 108 or other entity is required, then, in step 418, the transaction processing module of the processing unit 204 may modify the authorization request to include the determination of non-compliance with the rules in a data element, for further processing in step 422, as discussed below.

If, in step 412, the determination module determined that the transaction was in compliance with the transaction rules for the selected social benefit program, then, in step 420, the transaction processing module of the processing unit 204 may modify the authorization request to include the determination of compliance in a data element. In step 422, the modified authorization request, which includes a data element indicating compliance or non-compliance with the transaction rules, may be further modified by the transaction processing module to swap the primary account number stored in the corresponding data element with the mapped account number associated with the mapped identifier as included in the identified account profile 214.

In step 424, the transmitting unit 206 of the processing server 102 may electronically transmit the authorization request with the swapped account number and determination of compliance or non-compliance to the issuer 108 associated with the mapped account (e.g., corresponding to the selected social benefit program) via the payment network 104 using the payment rails. In step 426, the receiving unit 202 of the processing server 102 may receive an authorization response from the issuer 108 via the payment network 104 using the payment rails. The authorization response may be a transaction message including the data elements included in the authorization request, wherein a data element configured to store a response code includes a data value provided by the issuer 108 based on processing of the authorization request, such as a data value indicating approval or denial of the transaction. The authorization response may be a modification of the authorization request where, in addition to the response code, the message type indicator is modified to be indicative of an authorization response. In step 428, the transaction processing module of the processing unit 204 may swap the mapped account number stored in the corresponding data element in the authorization response back to the primary account number, and may subsequently process the authorization response using traditional methods and systems that will be apparent to persons having skill in the relevant art, such as discussed below with respect to the process 600 illustrated in FIG. 6.

### Exemplary Method for Selective Application of Rules to Transaction Processing for Mapped Transaction Accounts

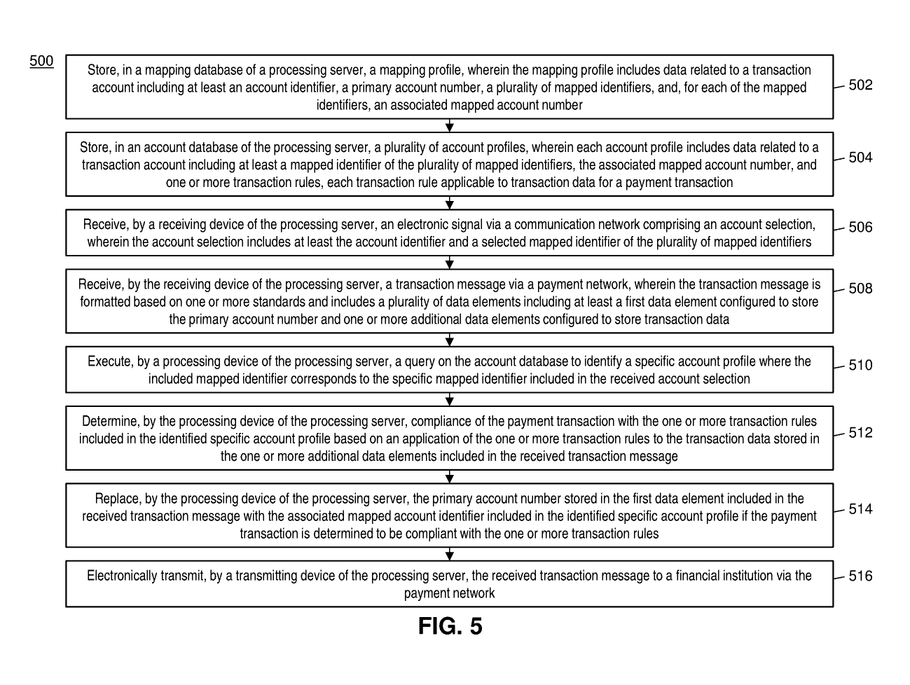

FIG. 5 illustrates a method 500 for the selective application of transaction rules to a transaction for one of a plurality of accounts related to social benefits programs mapped to a single primary account number.

In step 502, a mapping profile (e.g., mapping profile 210) may be stored in a mapping database (e.g., mapping database 208) of a processing server (e.g., the processing server 102), wherein the mapping profile includes data related to a transaction account including at least an account identifier, a primary account number, a plurality of mapped identifiers, and, for each of the mapped identifiers, an associated mapped account number. In step 504, a plurality of account profiles (e.g., account profiles 214) may be stored in an account database (e.g., the account database 212) of the processing server, wherein each account profile includes data related to a transaction account including at least a mapped identifier of the plurality of mapped identifiers, the associated mapped account number, and one or more transaction rules, each transaction rule applicable to transaction data for a payment transaction.

In step 506, an electronic signal may be received by a receiving device (e.g., the receiving unit 202) via a communication network comprising an account selection, wherein the account selection includes at least the account identifier and a selected mapped identifier of the plurality of mapped identifiers. In step 508, a transaction message may be received by the receiving device of the processing server via a payment network (e.g., the payment network 104), wherein the transaction message is formatted based on one or more standards and includes a plurality of data elements including at least a first data element configured to store the primary account number and one or more additional data elements configured to store transaction data.

In step 510, a query may be executed by a processing device (e.g., the processing unit 204) of the processing server on the account database to identify a specific account profile where the included mapped identifier corresponds to the specific mapped identifier included in the received account selection. In step 512, compliance of the payment transaction with the one or more transaction rules included in the identified specific account profile may be determined by the processing device of the processing server based on an application of the one or more transaction rules to the transaction data stored in the one or more additional data elements included in the received transaction message.

In step 514, the primary account number stored in the first data element included in the received transaction message may be replaced by the processing device of the processing server with the associated mapped account identifier included in the identified specific account profile if the payment transaction is determined to be compliant with the one or more transaction rules. In step 516, the received transaction message may be transmitted by a transmitting device (e.g., the transmitting unit 206) of the processing server to a financial institution via the payment network.

In one embodiment, the method 500 may also include storing, in the mapping profile, an indication indicating that the selected mapped identifier is to be used in subsequent payment transaction. In some embodiments, the received transaction message may be electronically transmitted to an issuing financial institution (e.g., the issuer 108) associated with the associated mapped account identifier included in the identified specific account profile. In a further embodiment, the method 500 may further include storing, by the processing device of the processing server, an indication in a second data element of the plurality of data elements included in the received transaction message indicating the determination of compliance, wherein the indication is stored prior to electronically transmitting the received transaction message.

In one embodiment, the received transaction message may be electronically transmitted to an acquiring financial institution if the payment transaction is determined not to be compliant with the one or more transaction rules. In a further embodiment, the transaction message may be received from the acquiring financial institution. In another further embodiment, the method 500 may also include modifying, by the processing device of the processing server, a message type indicator included in the received transaction message to indicate the transaction message as an authorization response. In yet another further embodiment, the method 500 may also include modifying, by the processing device of the processing server, a response code stored in a second data element of the plurality of data elements included in the received transaction message to indicate denial of the payment transaction for non-compliance with the one or more transaction rules.

In some embodiments, the account database and the mapping database may be a single database. In a further embodiment, each account profile may be stored in a mapping profile that includes the respective mapped identifier.

### Payment Transaction Processing System and Process

FIG. 6 illustrates a transaction processing system and a process 600 for the processing of payment transactions in the system. The process 600 and steps included therein may be performed by one or more components of the system 100 discussed above, such as the consumer 106, merchants 114, processing server 102, payment network 104, and issuer 108. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 650, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for selective application of rules to transaction processing for mapped transaction accounts. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for selective application of rules to transaction processing for mapped transaction accounts, comprising:
storing, in a mapping database of a processing server, a mapping profile, wherein the mapping profile includes data related to a transaction account including at least an account identifier, a primary account number, a plurality of mapped identifiers, and, for each of the mapped identifiers, an associated mapped account number;
storing, in an account database of the processing server, a plurality of account profiles, wherein each account profile includes data related to a transaction account including at least a mapped identifier of the plurality of mapped identifiers, the associated mapped account number, and one or more transaction rules, each transaction rule applicable to transaction data for a payment transaction;
receiving, by a receiving device of the processing server, an electronic signal via a communication network comprising an account selection, wherein the account selection includes at least the account identifier and a selected mapped identifier of the plurality of mapped identifiers;
receiving, by the receiving device of the processing server, a transaction message via a payment network, wherein the transaction message is formatted based on one or more standards and includes a plurality of data elements including at least a first data element configured to store the primary account number and one or more additional data elements configured to store transaction data;
executing, by a processing device of the processing server, a query on the account database to identify a specific account profile where the included mapped identifier corresponds to the specific mapped identifier included in the received account selection;
determining, by the processing device of the processing server, compliance of the payment transaction with the one or more transaction rules included in the identified specific account profile based on an application of the one or more transaction rules to the transaction data stored in the one or more additional data elements included in the received transaction message;
replacing, by the processing device of the processing server, the primary account number stored in the first data element included in the received transaction message with the associated mapped account identifier included in the identified specific account profile if the payment transaction is determined to be compliant with the one or more transaction rules; and
electronically transmitting, by a transmitting device of the processing server, the received transaction message to a financial institution via the payment network.

2. The method of claim 1, further comprising:
storing, in the mapping profile, an indication indicating that the selected mapped identifier is to be used in subsequent payment transactions.

3. The method of claim 1, wherein the received transaction message is electronically transmitted to an issuing financial institution associated with the associated mapped account identifier included in the identified specific account profile.

4. The method of claim 3, further comprising:
storing, by the processing device of the processing server, an indication in a second data element of the plurality of data elements included in the received transaction message indicating the determination of compliance, wherein
the indication is stored prior to electronically transmitting the received transaction message.

5. The method of claim 1, wherein the received transaction message is electronically transmitted to an acquiring financial institution if the payment transaction is determined not to be compliant with the one or more transaction rules.

6. The method of claim 5, wherein the transaction message is received from the acquiring financial institution.

7. The method of claim 5, further comprising:
modifying, by the processing device of the processing server, a message type indicator included in the received transaction message to indicate the transaction message as an authorization response.

8. The method of claim 5, further comprising:
modifying, by the processing device of the processing server, a response code stored in a second data element of the plurality of data elements included in the received transaction message to indicate denial of the payment transaction for non-compliance with the one or more transaction rules.

9. The method of claim 1, wherein the account database and the mapping database are a single database.

10. The method of claim 9, wherein each account profile is stored in a mapping profile that includes the respective mapped identifier.

11. A system for selective application of rules to transaction processing for mapped transaction accounts, comprising:
a mapping database of a processing server configured to store a mapping profile, wherein the mapping profile includes data related to a transaction account including at least an account identifier, a primary account number, a plurality of mapped identifiers, and, for each of the mapped identifiers, an associated mapped account number;
an account database of the processing server configured to store a plurality of account profiles, wherein each account profile includes data related to a transaction account including at least a mapped identifier of the plurality of mapped identifiers, the associated mapped account number, and one or more transaction rules, each transaction rule applicable to transaction data for a payment transaction;
a receiving device of the processing server configured to receive
an electronic signal via a communication network comprising an account selection, wherein the account selection includes at least the account identifier and a selected mapped identifier of the plurality of mapped identifiers, and
a transaction message via a payment network, wherein the transaction message is formatted based on one or more standards and includes a plurality of data elements including at least a first data element configured to store the primary account number and one or more additional data elements configured to store transaction data;
a processing device of the processing server configured to
execute a query on the account database to identify a specific account profile where the included mapped identifier corresponds to the specific mapped identifier included in the received account selection,
determine compliance of the payment transaction with the one or more transaction rules included in the identified specific account profile based on an application of the one or more transaction rules to the transaction data stored in the one or more additional data elements included in the received transaction message, and
replace the primary account number stored in the first data element included in the received transaction message with the associated mapped account identifier included in the identified specific account profile if the payment transaction is determined to be compliant with the one or more transaction rules; and
a transmitting device of the processing server configured to electronically transmit the received transaction message to a financial institution via the payment network.

12. The system of claim 11, wherein the processing device of the processing server is further configured to store, in the mapping profile, an indication indicating that the selected mapped identifier is to be used in subsequent payment transactions.

13. The system of claim 11, wherein the received transaction message is electronically transmitted to an issuing financial institution associated with the associated mapped account identifier included in the identified specific account profile.

14. The system of claim 13, wherein
the processing device of the processing server is further configured to store an indication in a second data element of the plurality of data elements included in the received transaction message indicating the determination of compliance, and
the indication is stored prior to electronically transmitting the received transaction message.

15. The system of claim 11, wherein the received transaction message is electronically transmitted to an acquiring financial institution if the payment transaction is determined not to be compliant with the one or more transaction rules.

16. The system of claim 15, wherein the transaction message is received from the acquiring financial institution.

17. The system of claim 15, wherein the processing device of the processing server is further configured to modify a message type indicator included in the received transaction message to indicate the transaction message as an authorization response.

18. The system of claim 15, wherein the processing device of the processing server is further configured to modify a response code stored in a second data element of the plurality of data elements included in the received transaction message to indicate denial of the payment transaction for non-compliance with the one or more transaction rules.

19. The system of claim 11, wherein the account database and the mapping database are a single database.

20. The system of claim 19, wherein each account profile is stored in a mapping profile that includes the respective mapped identifier.
